(19) United States
(12) Patent Application Publication
(10) Pub. No.: US 2023/0003868 A1
(43) Pub. Date: Jan. 5, 2023

(54) SYSTEM AND METHOD FOR EVALUATION CENTROID RANGE-BEARING PROCESSING IN HIGH RESOLUTION COASTAL SURVEILLANCE RADAR

(71) Applicant: VIETTEL GROUP, Ha Noi City (VN)

(72) Inventors: Van Loi Nguyen, Ha Noi City (VN); Quoc Tuan Tran, Ha Noi City (VN); Trung Kien Tran, Ha Noi City (VN); Van Truong Tran, Ha Noi City (VN); Vu Hop Tran, Ha Noi City (VN)

(73) Assignee: VIETTEL GROUP, Ha Noi City (VN)

(21) Appl. No.: 17/671,277

(22) Filed: Feb. 14, 2022

(30) Foreign Application Priority Data
Jul. 2, 2021 (VN) 1-2021-04077

(51) Int. Cl. G01S 13/42

(52) U.S. Cl. CPC G01S 13/42

(57) ABSTRACT

The patent provides the system and the method of evaluation the centroid range-bearing processing in high resolution coastal surveillance radars to solve the problem of assessing the quality of centroid processing. The provided system includes blocks: Input data block, parameter calculation block, evaluation and export result block; The provided method includes steps: Loading input data, calculating parameters, evaluating and exporting results. The system and method provided in this invention solve the issue of the quality assessment of the radar system according to the battle-technical specification at the target centroid level.

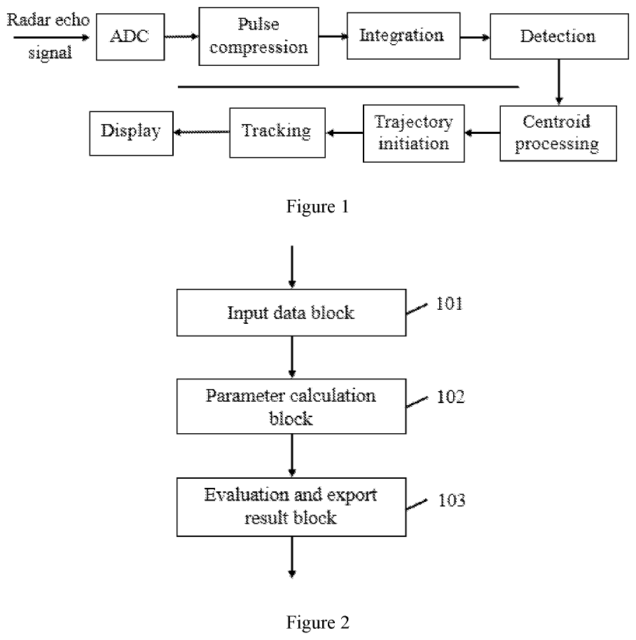

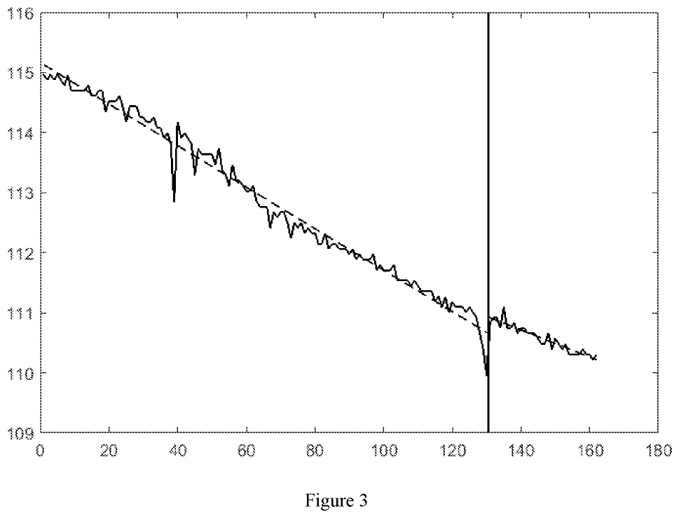

### TECHNICAL AREA

The patent refers to the system and method of assessing the centroid range-bearing processing (for short: centroid processing) in high resolution coastal surveillance radars with application to improve radar performance, serving the surveillance mission, monitoring, navigation, rescue.

### The Technical Status of the Invention

The system and method of assessing the centroid range-bearing processing are provided in this invention to address the issue of quality evaluation of a radar system according to the battle-technical specification at the target centroid level.

For high resolution coastal radars with the targets of ships, boats, on each radar scan, the echo signals from a target will form a bunch of hits (obtained after the digital signal processing block). The block “Centroid processing” gathers the hits of a target to form a bunch of hits and then calculate the position of the centroid of that bunch of hits. The centroid coordinates then will be used for the “Trajectory Initiation” and “Tracking” to form the target trajectory and display on the radar screen (Drawing 1)

The centroid processing block has a very important position in the radar data processing system because its output is the input of the target trajectory initiation and tracking. Large errors in centroid processing can lead to being unable to initialize the target trajectory or loss of target trajectory on the radar screen, these directly affect the quality of a radar system.

However, there are currently no research projects or inventions in the world referring to the construction of system and assessment method of centroid processing. The system and method mentioned in this invention aim to fill the above vulnerability. This means not only to help evaluate and improve the quality of a radar system, but also a premise to help us identify the appropriate parameters during the design a radar system.

### The Technical Nature of the Invention

The first purpose of the invention is to provide the system to evaluate the centroid processing for high resolution coastal surveillance radars. To achieve the above purpose, the provided system includes the following blocks:
Input data block: loads data for evaluation. Data is a file containing information of centroids of target hits such as: target ID, time, target range, azimuth, target state (1 if there are detected hits, 0 if not), target range and azimuth according to AIS (Automatic Identification System). In addition, 01 file containing the parameter values serving the algorithm calculation for the following blocks is also loaded in this step.
Parameter calculation block: the parameters serving the quality assessment of the centroid processing are calculated for each target. These parameters are: the ratio of break target hits, the ratio of miss detection, the ratio of reverse trend, the accuracy and the ratio of change points.
Evaluation and export result block: the average values of parameters in “Parameter calculation block” according to each target in the input data file are evaluated and returned in a “csv” output file.

The second purpose of the invention is to provide the method of assessing the centroid processing for high resolution coastal surveillance radars. To achieve the above purpose, the provided method includes 03 steps: Loading input data, Calculating parameters, Evaluating and exporting results.

### BRIEF DESCRIPTION OF DRAWINGS

Drawing 1: Scheme of radar data processing;

Drawing 2: Provided system in invention;

Drawing 3: Example of a change point of a series of radar target azimuths (degree) over consecutive scans.

### DETAILED INVENTION DESCRIPTION

According to the first implementation plan, the invention provides the system to assess the centroid processing for high resolution coastal surveillance radars. This is an independent system with the radar data processing system and includes three sub-blocks corresponding to three functions. Specifically:

Function 1: loading the input data (following called “Input data block 101”).

Function 2: parameter calculating (following called “Parameter calculation block 102”).

Function 3: evaluating and exporting results (following called “Evaluation and export result block 103”).

The output of Input data block 101 will be used as the input of Parameter calculation block 102. Similarly, the output of Parameter calculation block 102 will be used as the input of Evaluation and export result block 103.

The Input data block 101: The purpose of the block is to load the input data files collected through the radar system to serve the evaluation. These data files are formatted as “*.csv” and include:

A file “Data.csv” contains location (range, azimuth, time) of target centroids according to radar and AIS. Data collection is manipulated via radar screen. First, select a target on the screen. Then, choose to record and export data to “Data.csv” file from radar system.

A file “Constant.csv” contains the value of thresholds (constants) used for calculation in “Parameter calculation block 102”. Constants are γ₁ (first change threshold), γ₂ (second change threshold), φ (time between two change points) and weights Lᵢ (i=1, . . . , 6) of each parameter in step 2. Parameters γ₁, γ₂ and φ will be selected by statistical method. The values Lᵢ can be chosen equally and equal to ⅙, or can be chosen according to the priority level. For example, if we pay much attention to the structural stability we can put the weight of the parameter “ratio of change points” higher than the weights of remaining parameters.

The output of block 101 is given in Table 1

TABLE 1

| | | | | | | |
|---|---|---|---|---|---|---|
| Target | Time | Target | Target | Target state | Target | Target |
| ID | (s) | range by | azimuth by | | range by | azimuth by |
| | | radar | radar | | AIS | AIS |
| | | (m) | (degree) | | (m) | (degree) |

Where, target state takes value 1 if there are target detected hits and 0 if target is not detected (miss detection).

Parameter calculation block 102 performs calculation of parameters (the ratio of break target hits, the ratio of miss detection, the ratio of reverse trend, the accuracy and the ratio of change points) for each target. The output of block 102 is saved in a “csv” file with format given in Table 2.

TABLE 2

| | | | | | | |
|---|---|---|---|---|---|---|
| Target | Ratio of | Ratio of | Ratio of | Range | Azimuth | Ratio |
| ID | break | miss | reverse trend | accuracy | accuracy | of |
| | target hits | detection | | | | change |
| | | | | | | points |

Evaluation and export result block 103 performs the quality assessment of the centroid processing and exporting results in the form of a “csv” file in Table 3.

TABLE 3

| | | | | | | |
|---|---|---|---|---|---|---|
| | Ratio of | Ratio of | Ratio of | | | Ratio of |
| | break | miss | reverse | Range | Azimuth | change |
| | target hits | detection | trend | accuracy | accuracy | points |
| Mean | . . . | . . . | . . . | . . . | . . . | . . . |

Score

According to the second implementation plan, the invention provides the method of assessing the centroid processing for high resolution coastal surveillance radars. The method includes the following steps:

Step 1: Loading the input data;

At this step, two data sets (Data.csv and Constant.csv described above) are loaded to system and will be used for the parameter calculation block 102.

The output of step 1 is the data of each target shown as in Table 1 above.

Step 2: Calculating parameters;

Input: location information of centroids of target hits as given in Table 1; Constants are entered in step 1, where ID is the target identification number. Each target has only one ID to distinguish targets together. “Target state” is the logic value of 0 or 1 (value 0 corresponding when there is not target centroid—miss detection and value 1 when the target centroid appears on the radar screen).

Output: parameters (the ratio of break target hits, the ratio of miss detection, the ratio of reverse trend, the accuracy and the ratio of change points)

Realization:
The ratio of break target hits is calculated by:

$$Ratio of break target hits = \frac{All target centroids}{N umber of all scans} - 1$$

The ratio of miss detection:

$$Ratio of miss detection = 1 - \frac{N umber of times with target centroid}{Number of all scans}$$

The ratio of reverse trend:

$$Ratio of reverse trend = \frac{N umber of times the target centroid goes against the trend}{N umber of all scans}$$

Accuracy:
By range:

$$Range accuracy = \sqrt{\frac{\sum {( Range by radar - Range by AIS )}^{2}}{N}}$$

By azimuth:

$$Azimuth accuracy = \sqrt{\frac{\sum {( Azimuth by radar - Azimuth by AIS )}^{2}}{N}}$$

Where, N is the total number of times target centroid appears in radar and AIS data.
   The ratio of change points: determine the ratio of changing points based on location series (range, azimuth) of target centroids. Assuming the input data series of a target {(rᵢ, θᵢ)}ᵢ₌₁^{N}. To calculate the ratio of changing points we perform:
   Calculating the distances:

dᵢ=dist((rᵢ₊₁,θᵢ₊₁),(rᵢ,θᵢ)),i=1 . . . N−1
Where, dist is the distance function

dist((rᵢ₊₁,θᵢ₊₁),(rᵢ,θᵢ))=\sqrt{rᵢ₊₁²+rᵢ²−2rᵢ₊₁rᵢ cos(θᵢ₊₁−θᵢ)}
Determining the points (rᵢ, θᵢ) such that: dᵢ>γᵢ. Parameter γᵢ is chosen in step 1.
For each point (rᵢ, θᵢ) satisfying condition dᵢ>γᵢ:
   Determining the value (r, θ)_{left} which is the mean value of all points in the time duration φ before the point (rᵢ, θᵢ).
   Determining the value (r, θ)_{right} which is the mean value of all points in the time duration φ after the point (rᵢ, θᵢ). Value φ is chosen in step 1.
   If

dist((r,θ)_{left},(r,θ)_{right})>γ₂
then the point (rᵢ, θᵢ) is called “a possible change point” and denoted by (rᵢ*, θᵢ*). Value γ₂ is chosen in step 1.

{(rᵢ*,θᵢ*)}dist((r,θ)_{left},(r,θ)_{right})(rᵢ*,θᵢ*)(rᵢ₋₁*,θᵢ₋₁*)φ(rᵢ*,θᵢ*)
Arrange the possible change points by in descending order of

{(rᵢ*,θᵢ*)}dist((r,θ)_{left},(r,θ)_{right})(rᵢ*,θᵢ*)(rᵢ₋₁*,θᵢ₋₁*)φ(rᵢ*,θᵢ*).

If the time difference between the point and is greater or equal, then is a change point (Drawing 3).

The ratio of change points is determined by:

$$Ratio of change points = \frac{Number of change points}{N} .$$

### Step 3: Evaluating and Exporting Results;

Input: parameters evaluated for each target in table 2.

Output: evaluation results in table 3.

Realization:
Find the average values of all parameters by number of targets:

$$Average ratio break target hits = \frac{1}{N} {\sum }_{k = 1}^{N} Ratio of break target hits of k - th target$$

$$Average ratio of miss detection = \\ \frac{1}{N} {\sum }_{k = 1}^{N} Ratio of miss detection of k - th target$$

$$Average ratio of reverse trend = \frac{1}{N} {\sum }_{k = 1}^{N} Ratio of reverse trend of k - th target$$

$$Average accuracy = \frac{1}{N} {\sum }_{k = 1}^{N} Accuracy of k - th target$$

$$Average ratio of change points = \\ \frac{1}{N} {\sum }_{k = 1}^{N} Ratio of change points of k - th target$$

where, N is the total number of targets in the output of step 2.
Evaluation result is estimated by:

$$Evaluation result = {\sum }_{i = 1}^{6} {L}_{i} * ( i - th parameter )$$

where, Lᵢ is the weight of i-th parameter.
   The evaluation result is exported as a “csv” file (Table 3).

While preferred embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. The system to evaluate the target centroid range-bearing processing in high resolution coastal surveillance radars includes the following blocks:
input data block loads data for evaluation, these data files are formatted as “*.csv” and include:
a file “Data.csv” contains location (range, azimuth, time) of target centroids according to radar and AIS, data collection is manipulated via radar screen, first, select the target on the screen, then choose to record and export data to “Data.csv” file from radar system;
a file “Constant.csv” contains the value of thresholds (constants) used for calculation in “Parameter calculation block 102”, Constants are γᵢ (first change threshold), γ₂ (second change threshold), φ (time between two change points) and weights Lᵢ (i=1, . . . , 6) of each parameter in step 2, Parameters γ₁, γ₂ and φ will be selected by statistical method, The values Lᵢ can be chosen equally and equal to ⅙, or chosen according to the priority level, for example, if we pay much attention to the structural stability we can put the weight of the parameter “ratio of change points” higher than the weights of remaining parameters;
the output of “Input data block” is given in following table

| | | | | | | |
|---|---|---|---|---|---|---|
| Target | Time | Target | Target | Target state | Target | Target |
| ID | (s) | range by | azimuth by | | range by | azimuth by |
| | | radar | radar | | AIS | AIS |
| | | (m) | (degree) | | (m) | (degree) |

where, target state takes value 1 if there are target detected hits and 0 if target is not detected (miss detection);
parameter calculation block performs calculation of parameters (the ratio of break target hits, the ratio of miss detection, the ratio of reverse trend, the accuracy and the ratio of change points) for each target, the output of block is the a “csv” file with format given in table below:

| | | | | | | |
|---|---|---|---|---|---|---|
| Target | Ratio of | Ratio of | Ratio of | Range | Azimuth | Ratio |
| ID | break | miss | reverse trend | accuracy | accuracy | of |
| | target hits | detection | | | | change |
| | | | | | | points |

Evaluation and export result block performs the quality assessment of the centroid processing and exporting evaluation results in the form of a “csv” file in table,

| | Ratio of | Ratio of | Ratio of | | | Ratio of |
|---|---|---|---|---|---|---|
| | break | miss | reverse | Range | Azimuth | change |
| | target hits | detection | trend | accuracy | accuracy | points |
| Mean | . . . | . . . | . . . | . . . | . . . | . . . |

Score

2. A method to evaluate the target centroid range-bearing processing in high resolution coastal surveillance radars includes the following steps:
Step 1: Loading the input data;
at this step, two data sets (Data.csv and Constant.csv described above) are loaded to system and will be used for the parameter calculation block;
the output of step 1 is the data of each target shown as in table below,

| | | | | | | |
|---|---|---|---|---|---|---|
| Target | Time | Target | Target | Target state | Target | Target |
| ID | (s) | range by | azimuth by | | range by | azimuth by |
| | | radar | radar | | AIS | AIS |
| | | (m) | (degree) | | (m) | (degree) |

Step 2: calculating parameters;
input: location information of target centroids as given in table in step 1; constants are entered in step 1, where ID is the target identification number, Each target has only one ID to distinguish targets together, “Target state” is the logic value of 0 or 1 (value 0 corresponding when there is not target centroid—miss detection and value 1 when the target centroid appears on the radar screen);
output: parameters (the ratio of break target hits, the ratio of miss detection, the ratio of reverse trend, the accuracy and the ratio of change points)
realization:
the ratio of break target hits is calculated by:
$$Ratio of break target hits = \frac{All target centroids}{Number of all scans} - 1$$
the ratio of miss detection:
$$Ratio of miss detection = 1 - \frac{N u mber of times with target centroid}{Number of all scans}$$
the ratio of reverse trend:
$$Ratio of reverse trend = \frac{N umber of times the target centroid goes against the trend}{N umber of all scans}$$
accuracy:
By range:
$$Range accuracy = \sqrt{\frac{\sum {( Range by radar - Range by AIS )}^{2}}{N}}$$
By azimuth:
$$Azimuth accuracy = \sqrt{\frac{\sum {( Azimuth by radar - Azimuth by AIS )}^{2}}{N}}$$
Where, N is the total number of times target centroid appears in radar and AIS data;
The ratio of change points: determine the ratio of changing points based on location series (range, azimuth) of target centroids, Assuming the input data series of a target {(rᵢ, θᵢ)}ᵢ₌₁^{N}, to calculate the ratio of changing points we perform:
calculating the distances:
dᵢ=dist((rᵢ₊₁,θᵢ₊₁),(rᵢ,θᵢ)),i=1 . . . N−1
where, dist is the distance function
dist((rᵢ₊₁,θᵢ₊₁),(rᵢ,θᵢ))=\sqrt{rᵢ₊₁²+rᵢ²−2rᵢ₊₁rᵢ cos(θᵢ₊₁−θᵢ)}
determining the points (rᵢ, θᵢ) such that: dᵢ>γᵢ, parameter γᵢ is chosen in step 1,
for each point (rᵢ, θᵢ) satisfying condition dᵢ>γᵢ:
determining the value (r, θ)_{left} which is the mean value of all points in the time duration φ before the point (rᵢ, θᵢ),
determining the value (r, θ)_{right} which is the mean value of all points in the time duration φ after the point (rᵢ, θᵢ), Value φ is chosen in step 1,
if
dist((r,θ)_{left},(r,θ)_{right})>γ₂
then point (rᵢ, θᵢ) is called “a possible change point” and denoted by (rᵢ*, θᵢ*), Value γ₂ is chosen in step 1;
arrange the possible change points {(rᵢ*, θᵢ*)} by in descending order of dist((r, θ)_{left}, (r, θ)_{right}), if the time difference between the point (rᵢ*, θᵢ*) and (rᵢ₋₁*, θᵢ₋₁*) is greater or equal φ, then (rᵢ*, θᵢ*) is a change point;
the ratio of change points is determined by:
$$Ratio of change points = \frac{Number of change points}{N} ;$$
Step 3: evaluating and exporting results;
input: parameters evaluated for each target in table:

| | | | | | | |
|---|---|---|---|---|---|---|
| Target | Ratio of | Ratio of | Ratio of | Range | Azimuth | Ratio |
| ID | break | miss | reverse trend | accuracy | accuracy | of |
| | target hits | detection | | | | change |
| | | | | | | points |

Output: evaluation results in table

| | Ratio of | Ratio of | Ratio of | | | Ratio of |
|---|---|---|---|---|---|---|
| | break | miss | reverse | Range | Azimuth | change |
| | target hits | detection | trend | accuracy | accuracy | points |
| Mean | . . . | . . . | . . . | . . . | . . . | . . . |

Score
realization:
find the average values of all parameters by number of targets:
$$Average ratio break target hits = \frac{1}{N} {\sum }_{k = 1}^{N} Ratio of break target hits of k - th target$$
$$Average ratio of miss detection = \\ \frac{1}{N} {\sum }_{k = 1}^{N} Ratio of miss detection of k - th target$$
$$Average ratio of reverse trend = \frac{1}{N} {\sum }_{k = 1}^{N} Ratio of reverse trend of k - th target$$
$$Average accuracy = \frac{1}{N} {\sum }_{k = 1}^{N} Accuracy of k - th target$$
$$Average ratio of change points = \\ \frac{1}{N} {\sum }_{k = 1}^{N} Ratio of change points of k - th target$$
where, N is the total number of targets in the output of step 2;
evaluation result is estimated by:
$$Evaluation result = {\sum }_{i = 1}^{6} {L}_{i} * ( i - th parameter )$$
where, Lᵢ is the weight of i-th parameter;
The evaluation result is exported in a “csv” file.
